(19) United States
(12) Patent Application Publication
(10) Pub. No.: US 2005/0287361 A1
(43) Pub. Date: Dec. 29, 2005

(54) Halogen free tapes & method of making same

(75) Inventors: Rafael Garcia-Ramirez, Dripping Springs, TX (US); C. Carol Guilbert, Austin, TX (US); Mario A. Perez, Burnsville, MN (US); Krishnakant P. Vora, Round Rock, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/874,726

(22) Filed: Jun. 23, 2004

(51) Int. Cl. C08L 1/00

(52) U.S. Cl. 428/343

(57) ABSTRACT

Provided is a composition having a halogen-free polymeric material, a halogen-free flame retardant, and a coupling agent. Also provided is a method of making a tape containing the steps of forming the previously recited composition into a backing; and applying an adhesive to a surface of the backing to form the tape. When the tape is tested using UL 510 (7^{th} Ed.), it has at least one of the physical properties: an elongation at break of at least 60%; a tensile strength at break of at least 1500 psi; a dielectric strength of at least 1,000 V per mil of tape thickness; an average adhesion strength of at least 0.175 N/mm; and a retention of at least 90% of an original average dielectric strength after the tape is conditioned for 96 hours in air with a temperature of 23.0° C. and a relative humidity of 96%.

### CROSS REFERENCE TO RELATED APPLICATIONS

This application is related to the following patent applications filed on even date herewith: Attorney Docket Numbers 59433US002 and 59893US002.

### FIELD OF INVENTION

The present invention relates generally to electrical insulating films and tapes for use in various applications, such as automotive applications. The present invention further relates to electrical insulating films and tapes, including halogen-free electrical insulating films and tapes, which meet rigorous industry standards for flame retardancy, weatherability, thickness, tensile strength, elongation, dielectric strength, adhesion strength, moisture absorption, temperature resistance, deformation, longevity, and/or conductor corrosion.

### BACKGROUND

Electrical insulating films in the art have varying degrees of flame retardancy and a range of mechanical properties. Higher performing films usually contain halogen. Vinyl chloride, which is often present in electrical insulating films and tapes, is a common source of halogen. It is desirable to minimize the halogen content of electrical insulating films and tapes because toxic fumes are produced when films and tapes containing halogens are burned, either accidentally or upon disposal.

Halogen-free polymeric compositions have been used to produce insulating films for use in the electrical industry. The halogen-free polymeric compositions that have been used, however, do not exhibit a sufficient degree of flame retardancy. As such, flame-retardant fillers have been incorporated into the films to provide or enhance flame retardancy of the insulating films while attempting to preserve desired mechanical properties of the insulating films. The flame-retardant fillers that have been used, however, are not necessarily free of halogen. Some include bromine.

Although some halogen-free insulating films with varying degrees of flame retardance exist in the art, the films do not generally meet industry standards for both flame retardancy and mechanical properties. To achieve a high degree of flame retardancy in a halogen-free film, the concentration of flame retardant filler in the film typically becomes so high that the physical properties of the film are compromised. Some examples of these physical properties that may be compromised include, among other, mechanical strength, flexibility, and/or elongation. This compromising of mechanical properties is unsatisfactory, especially for electrical insulating tape, which desirably will mirror, or even exceed, the mechanical strength, elasticity, and flexibility properties of halogen-containing electrical insulating tapes.

Although existing halogen-free electrical insulating films and tapes have increased the knowledge base, further improvements are needed that will yield halogen-free electrical insulating films and tapes that meet or exceed the flame retardancy and mechanical properties of halogen-containing electrical insulating films and tapes. The present invention meets this challenge.

### SUMMARY

The present invention includes various compositions and tapes. One exemplary embodiment of the invention includes composition comprising (a) a halogen-free polymeric material; (b) a halogen-free flame retardant; and (c) a coupling agent. In another exemplary embodiment of the invention, the composition comprises at least about 40 weight percent halogen-free flame retardant, based on the total weight of the composition.

One exemplary method of making a tape of the present invention comprises the steps of (a) forming a composition comprising (i) a halogen-free polymeric material, (ii) a halogen-free flame retardant, and (iii) a coupling agent into a backing; and (b) applying an adhesive located on a surface of the backing to form the tape. The tape, when tested in accordance with the procedures of Underwriters Laboratories UL 510, Seventh Edition, exhibits at least one of the following physical properties: an elongation at break of at least about 60%; a tensile strength at break of at least about 1500 psi; a dielectric strength of at least about 1,000 V per mil of tape thickness; an average adhesion strength of at least about 0.175 N/mm; and a retention of at least 90 percent of an original average dielectric strength after the tape is conditioned for 96 hours in air with a temperature of about 23.0° C. and a relative humidity of about 96%. In another exemplary embodiment, the step of forming the composition into a backing comprises calendering. Yet another exemplary method further comprises the step of irradiating the backing or tape with electron bean.

In this document, all numbers are assumed to be modified by the term “about”.

### BRIEF DESCRIPTION OF THE DRAWINGS

The invention can be further described with the figures below, wherein:

FIG. 1 is a schematic view of an exemplary calendaring process.

These figures are idealized, not drawn to scale and are intended only for illustrative purposes.

### DETAILED DESCRIPTION OF THE INVENTION

The present invention encompasses a composition that includes a polymeric material, a flame retardant, and an optional processing additive. The polymeric material, the flame retardant, and/or the optional processing additive may be halogen-free. Use of the polymeric material, the flame retardant, and the optional processing additive that are all halogen-free results in the composition being halogen-free. The present invention further includes a method of making the composition, such as the halogen-free composition.

The composition may be formed into an electrically insulating film (also referred to herein as “tape backing”) that, after being coated on at least one surface with an adhesive, yields an electrical insulating tape. Likewise, the halogen-free composition may be formed into a halogen-free electrically insulating film that, after being coated on at least one surface with a halogen-free adhesive, yields a halogen-free electrical insulating tape. The halogen-free electrical insulating tape, when burned, does not produce toxic fumes characteristically produced when electrical insulating tape containing halogen is burned. Additionally, electrical insulating tape, including halogen-free electrical insulating tape, produced in accordance with the present invention is capable of meeting various performance-based industry standards for electrical insulating tape.

Underwriters Laboratories UL 510, Seventh Edition, entitled “Standard for Polyvinyl Chloride, Polyethylene, and Rubber Insulating Tape” (referred to herein as “UL 510”), is an example of a set of performance-based industry standards for electrical insulating tape. UL 510 prescribes a set of minimum standards such as flame retardancy, weatherability, thickness, tensile strength, elongation, dielectric strength, adhesion strength, moisture absorption, temperature resistance, deformation, longevity, and conductor corrosion. UL 510 is a standard that covers, among other things, thermoplastic and rubber tapes for use as electrical insulation at not more than 600 V and at 80° C. Section 4 of UL 510 pertains to flame testing and applies to all of the tapes covered by the standard. The physical properties determined according to UL 510, i.e., Sections 6 to 15, pertain to thermoplastic tape, and more specifically to the “PE tape”. Because the present invention is at least based on uses of halogen-free components, the standards according to the PE tape is an appropriate standard to use.

Other applicable industry standards include IEC 60454 entitled “Specifications for Pressure-Sensitive Tapes for Electrical Purposes, Part 2: Methods of Test” for Europe and JIS C2107 entitled “Testing Methods of Pressure Sensitive Adhesive Tapes for Electrical Insulation” for Japan.

The halogen-free composition of the present invention may be processed into halogen-free tape that is capable of meeting the UL 510 requirements for electrical insulating tape. To produce such a halogen-free tape, the halogen-free composition is prepared by mixing together suitable amounts of the halogen-free polymeric material, the halogen-free flame retardant, and, optionally, the halogen-free processing additive. The halogen-free composition may be formed into the halogen-free film using any suitable film formation technique, such as extrusion and calendering. A halogen-free adhesive may then be applied onto one or both major surfaces of the halogen-free film to form the halogen-free tape. The halogen-free tape may then be irradiated with a suitable energy source, such as an electron-beam. Halogen-free tape produced in accordance with the present invention has surprisingly been found to meet all of the different UL 510 requirements for PE thermoplastic tape along with the flame retardancy standards of UL 510. Suitable component concentrations and processing procedures for the manufacture of the above UL 510 compliant halogen-free tape are described herein.

As used herein, the phrases “halogen-free” and “free of halogen,” and any derivative of either phrase, mean free, or essentially free, of halogen, such as halogen atoms present in the molecular structure of a substance. As used herein, the term “ultra-trace concentration” means a concentration of 0.01 weight percent, or less, in the composition, film, or tape, based on the total weight of the composition, film, or tape, respectively. Halogen atoms may be present in an ultra-trace concentration in a particular halogen-free composition, film, or tape due to use of a halogen-containing substance merely as a catalyst for synthesis of a constituting material of a component used when preparing compositions, films and/or tapes of the present invention. Compositions, films, or tapes of the present invention that contain an ultra-trace concentration of halogen are considered to be essentially free of halogen. Therefore, with regard to halogen-free compositions, films, and tapes of the present invention, the terms “halogen-free” and “free of halogen” do encompass compositions, films, and tapes produced in accordance with the present invention that nevertheless include a miniscule amount of halogen atoms detected at an ultra-trace concentration by analysis of the compositions, films, and/or tapes using mechanical analysis means.

The polymeric material incorporated in the compositions of the present invention may be free of halogen. In the halogen-free compositions of the present invention, the polymeric material is free of halogen. The polymeric material may include thermoplastic polymeric materials, which contribute certain physical properties, such as elasticity, to the composition that are beneficial for meeting industry standards. Examples of suitable polymeric materials include: terpolymers of ethylene-propylene-diene monomer (EPDM), ethylene vinyl acetate (EVA), and polymeric blends of EPDM and EVA. EPDM, for example, has various physical properties that are desirable for insulating tapes, such as resistance to heat, oxidation, ozone, and weather aging. Furthermore, EPDM has good electrical resistivity and responds well to high filler loading. Suitable concentrations of the polymeric material in the composition range from as low as 30% by weight to as high as 60% by weight, based on the total weight of the composition. In some exemplary embodiments of the composition, suitable concentrations of the polymeric material in the composition range from as low as 30% by weight to as high as 45% by weight, based on the total weight of the composition, such as the halogen-free composition.

In one exemplary embodiment of the present invention, the polymeric material includes EVA at a concentration that ranges from 0% by weight to as high as 40% by weight and EPDM at a concentration that ranges from as low as 60% by weight to as high as 100% by weight, based on the total weight of the polymeric material. Other polymers, such as higher tensile strength polyethylene-type polymers (e.g., “Exact 4056” higher tensile strength polymer that is commercially available from Exxon Mobil of Irving, Tex.), may also be included in the polymeric material to elicit beneficial physical properties such as tensile strength.

Flame retardant is included in the present invention to provide resistance to heat and fire, which may sometimes be encountered in various applications of electrical insulating tape. The flame retardant may be halogen-free. Some suitable examples of the flame retardant include metallic inorganic compounds. Significant quantities of halogen-free metallic inorganic flame retardant may be included in the composition of the present invention to help yield the film, including the halogen-free film, that exhibits flame retardancy sufficient to meet various industry standards, including the UL 510, IEC 60454, and JIS C2107 flame retardancy standards. The flame retardant may be present in the composition, including the halogen-free composition, at a concentration as low as 40% by weight and as high as 70% by weight, based on the total weight of the composition. Some embodiments of the electrical insulating tape, including the halogen-free electrical insulating tape, particularly suited to meeting the flame retardancy requirements of UL 510, IEC 60454, and JIS C2107 include film (tape backing) formed from the composition with a flame retardant concentration as low as 50% by weight and as high as 60% by weight, based on the total weight of the composition.

To achieve compliance of the tape of the present invention, including the halogen-free tape, with all of the UL 510 standards applicable to PE thermoplastic tape, the composition of the present invention, such as the halogen-free composition, may include a flame retardant concentration as low as 40% by weight and as high as 70% by weight, with flame retardant concentrations in some embodiments being as low as 50% by weight and as high as 60% by weight, based on the total weight of the composition.

Examples of suitable flame retardants include metallic inorganic compounds, such as metal hydroxides. Examples of suitable metal hydroxides include alumina trihydrate (also referred to as aluminum hydroxide, alumina, hydrated alumina, and aluminum tryihydroxide; and hereinafter referred to as ATH), calcium hydroxide, magnesium hydroxide, zirconium hydroxide, barium hydroxide, and the like; metal carbonates such as basic magnesium carbonate, dolomite, and the like; metal hydrates such as hydrotalcite, borax, and the like; and any combination of any of these in any proportion.

ATH is particularly suited for use as a flame retardant in the present invention. ATH acts as a heat sink and absorbs a portion of the heat of combustion to retard combustion of the polymeric material incorporated in the tape backing. ATH also releases water when heated, which dilutes the concentration of combustible gases in the atmosphere surrounding electrical insulating tapes of the present invention, including halogen-free electrical insulating tapes.

Silane-treated flame retardant, such as silane-coated ATH, is particularly suited for use as the flame retardant. Examples of suitable silane coupling agents for surface treating the flame retardant include vinyl silanes (e.g., A-172 DLC silane), methacryl silanes (e.g., A-174 DLC silane), amino silanes (e.g., A-1100 DLC and A-1120 silane), that are all commercially available from Natrochem, Inc. of Savannah, Ga.; liquid tetrasulfide silanes (e.g., SILQUEST A-1289 silane), liquid disulfide silanes (e.g., SILQUEST A-1589 silane), and polysulfide silanes (e.g. SILQUEST A-189 silane), that are all commercially available from OSI Specialties Division of Witco Corporation of Danbury, Conn.; and any combination of any of these in any proportion. Some examples of commercially available silane-coated ATH include MICRAL 1500-SH1 and MICRAL 1500-SH2 ATH, both commercially available from J. M. Huber Corporation of Edison, N.J.

Examples of the optional processing additive include coupling agents, release agents, and combinations of these. Coupling agents may be incorporated in the composition of the present invention, including the halogen-free composition, to improve physical properties of the composition and/or tape backings prepared from the composition. Release agents may be incorporated in the composition of the present invention, including the halogen-free composition, to aid processing the composition into a film.

Coupling agents incorporated in the composition of the present invention, including the halogen-free composition, can help to increase attractive forces between the polymeric material and the flame retardant. Examples of suitable coupling agents include neoalkoxy-titanate coupling agents (e.g., CAPS coupling agent commercially available from Kenrich Petrochemical, Inc.), neoalkoxy zirconate coupling agents, isocyanate coupling agents (e.g., MONDUR MR polyurethane pre-polymer commercially available from Bayer Corporation), maleated polyolefin coupling agents (e.g., EPOLENE G3003 coupling agent commercially available from Eastman Chemical Company), and any combination of any of these in any proportion.

Examples of suitable neoalkoxy titanate coupling agents include titanium IV 2,2(bis 2-propenolatomethyl) butanolato, tris neodecanoato-O; titanium IV 2,2(bis 2-propenolatomethyl) butanolato, tris (dodecyl) benzenesulfonato-O; titanium IV 2,2(bis 2-propenolatomethyl) butanolato, tris (dioctyl) phosphato-O; titanium IV 2,2(bis 2-propenolatomethyl) butanolato, tris (dioctyl) pyrophosphato-O; titanium IV 2,2(bis 2-propenolatomethyl) butanolato, tris (2-ethylenediamino) ethylato; titanium IV 2,2(bis 2-propenolatomethyl) butanolato, tris (3-amino) phenylato; and titanium IV 2,2(bis 2-propenolatomethyl) butanolato, tris (6-hydroxy) hexanoato-O; and any combination of any of these in any proportion.

Examples of suitable neoalkoxy zirconate coupling agents include zirconium IV 2,2(bis-2-propenolatomethyl) butanolato, tris neodecanoato-O; zirconium IV 2,2(bis-2-propenolatomethyl) butaolato, tris (dodecyl) benzenesulfonato-O; zirconium IV 2,2(bis-2-propenolatomethyl) butanolato, tris (dioctyl) phosphato-O; zironcium IV 2,2(bis-2-propenolatomethy) butanolato, tris 2-methyl-2-propenoato-O; zirconium IV 2,2(bis-2-propenolatomethyl) butanolato, tris (dioctyl) pryophoaphato-O; zirconium IV 2,2-(bis-2-propenolato) butanolato, tris 2-propenoato-O; zirconium IV 2,2(bis-2-propenolatomethyl) butanolato, tris (2-ethylenediamino) ethylato; zirconium IV bis (2,2-Dimethyl) 1,3-propanediolato, bis (9, 10-11, 12 diepoxy) octadecanoato-O; zirconium IV 2-ethyl,2-propenolatomethyl 1,3-propanediolato bis mercaptophenylato; zirconium IV 1,1(bis-2-propenolatomethyl) butanolato, tris (2-amino) pnenylato; and any combination of any of these in any proportion.

The concentration of coupling agents in the composition of the present invention may be as low as 0.1% and as high as 10.0% by wt, with coupling agent concentrations in some embodiments of the composition being as low as 0.5% and as high as 1.5% by wt, based on the total weight of the composition, such as the halogen-free composition. In some exemplary embodiments, the concentration of the coupling agent in the composition is 0.7% by wt, based on the total weight of the composition.

Release agents incorporated in the composition of the present invention, including the halogen-free composition, simplify processing of the composition, such as the halogen-free composition, into film for use as tape backings. Examples of suitable release agents include the following products, which are each commercially available from Struktol Company of America of Stow, Ohio: mixtures of fatty acid metal soaps and amides (e.g., STRUKTOL A 50, STRUKTOL A 60, STRUKTOL A 61, STRUKTOL EF 44 A, and STRUKTOL WB 42 release agents); mixtures of rubber compatible non-hardening fatty acid soaps (e.g., STRUKTOL EP 52 release agent); fatty acid esters and soap-bound fillers (e.g., STRUKTOL W 34 and STRUKTOL WB 212 release agents); mixtures of lubricants and fatty acid derivatives (e.g., STRUKTOL W 80 release agent); mixtures of esters and zinc soaps of fatty acids (e.g., STRUKTOL WA 48 release agent); mixtures of fatty acid soaps, predominantly calcium-based (e.g., STRUKTOL WB 16 release agent); mixtures of aliphatic fatty acid esters and condensation products (e.g., STRUKTOL WB 222 release agent); condensation products of fatty acid derivatives and silicones (e.g., STRUKTOL WS 180 release agent); organosilicone compounds on inorganic carriers (e.g., STRUKTOL WS 280 release agent); and any combination of any of these in any proportion.

The release agent concentration in compositions of the present invention, including halogen-free compositions, may be as low as 0.1% and as high as 10.0% by wt, with the concentration of release agents in some embodiments of the composition being as low as 0.5% and as high as 2.0% by wt, based on the total weight of the composition, such as the halogen-free composition. In some exemplary embodiments, the release agent concentration in the composition is 1.0% by wt, based on the total weight of the composition.

Besides the processing additives, the composition of the present invention, including the halogen-free composition, may optionally also include additional materials (additional halogen-free materials in the case of the halogen-free composition) such as, pigments, antioxidants, stabilizing agents, oils, processing aids, fillers, cross-linking materials, acrylic materials, and any combination of any of these in any proportion. The concentration of these additional materials in compositions of the present invention may be any concentration to provide a desired result.

The compositions of the present invention, including halogen-free compositions, may be prepared by blending together the polymeric material, the flame retardant, and the optional processing additive(s) in an appropriate mixing apparatus. For example, the components of the composition may generally be combined in any order and mixed in a Banbury mixer operating at 45 to 65 rotations-per-minute (rpm) for a period of approximately five minutes at a component temperature (in the mixer) of 140° C. After the components have been blended together to form the composition, the composition may then be milled and banded in a conventional two-roll mill to minimize non-homogeneous regions in the composition.

Any desired additional materials such as pigments, antioxidants, oils, processing aids, neutralizers, rheology modifiers, and fillers may also be added to the polymeric material, the flame retardant, and the processing additive prior to mixing. However, if cross-linking agents or acrylic materials are to be incorporated in the composition, these cross-linking agents or acrylic materials should be added to the composition in a second mixing step at a temperature that is low enough to prevent premature cross-linking, after all other desired components of the composition have been incorporated in the composition.

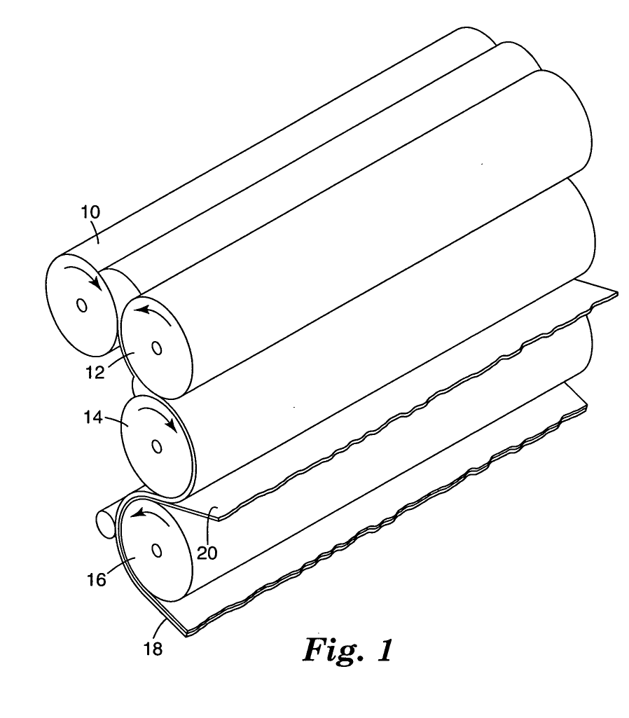

The composition of the present invention, including the halogen-free compositions, may be calendered to form the films of the present invention and elicit beneficial physical properties. The composition may be continuously fed from the milling machine, such as the two-roll mill, into a calender machine to process the composition into film. Any release agent, such as any of the release agents described above, may be included in the composition to facilitate continuous and stable release of the composition (as film), from rolls of the calender machine, during the film-making process. Calendering of the composition into film, at the lowest possible calender-roll temperature, is believed to improve the tensile strength of the film, such as the halogen-free film, by locking the molecular orientation of the composition in the machine direction of the calender machine. Some exemplary calendering roll temperatures may be as low as 180° F. and as high as 225° F., with suitable calendering roll temperatures during production of some embodiments of the temperatures being as low as 190° F. and as high as 215° F. FIG. 1 shows an exemplary calendering process using two upper rolls 10 and 12, middle roll 14, bottom roll 16 with film of the present invention 18 and optional liner 20. In one exemplary calendering process, the two upper rolls and the middle rolls are heated while the bottom roll is not heated.

Films of the present invention, including halogen-free films, are useful backings for electrical insulating tape. Adhesive may be applied to one or both major surfaces of the film using known processes, such as, for example, adhesive lamination. For production of halogen-free electrical insulating tape, halogen-free adhesive is applied to halogen free film (backing). Examples of suitable halogen-free adhesives include acrylic adhesives such as hot-melt acrylic adhesive (e.g., A+hot-melt acrylic adhesive commercially available from 3M of St. Paul, Minn.); hot-melt rubber adhesive; water-based latex acrylic adhesive; silicone adhesives; thermoplastic elastomers; flame-retarded adhesives; any other halogen-free adhesive known in the art; and any combination of any of these in any proportion.

Films of the present invention, including halogen-free films, may be irradiated using any suitable energy source, such as an electron-beam, to elicit physical properties beneficial for complying with industry standards for electrical insulating tape such as tensile strength, flame retardancy, and adhesion strength. Suitable irradiation dosages for films of the present invention, including halogen-free films, are as low as 10 mega-rads (Mrad) and as high as 30 Mrad. In some embodiments, suitable irradiation dosages for films of the present invention, including halogen-free films, are as low as 15 Mrad and as high as 25 Mrad. An example of suitable irradiation parameters for an electron-beam generator used to irradiate films of the present invention, including halogen-free films, includes a voltage setting of 175 keV, a current setting of 7 mA, and a machine constant (K) of 64.

Line speeds while irradiating films of the present invention, including halogen-free films, may generally be as low as 5 feet per minute (fpm) and as high as 20 fpm. In some embodiments, suitable line speeds while irradiating films of the present invention, including halogen-free films, may be as low as 10 feet per minute and as high as 15 fpm. In various embodiments, suitable radiation dosages per linear foot of films of the present invention, including halogen-free films, may be as low as 1.0 Mrad per linear foot and as high as 2.5 Mrad per linear foot.

As discussed above, at least one embodiment of the halogen-free electrical insulating tape of the present invention, when tested according to UL 510, meets all of its requirements. As such, the halogen-free electrical insulating tape, when tested according to UL 510, exhibits a dielectric strength of at least 1,000 volts per mil of the tape thickness (backing plus adhesive), retains at least 90% of an original average dielectric strength after being conditioned for 96 hours in air with a temperature of 23.0±1.0° C. and a relative humidity of 96%±2%, has an average adhesion strength of at least 0.175 N/mm, exhibits an elongation at break of at least 60%, has a tensile strength at break of at least 1500 pounds per square inch (psi), and complies with all of the other standards in UL 510.

One example of such a halogen-free tape that meets all of the requirements of UL 510 includes halogen-free backing manufactured from the halogen-free composition that includes 25% by wt EVA, 6% by wt EPDM, 60% by wt ATH flame retardant, 1.0% by wt CAPS coupling agent, and 0.9% by wt STRUKTOL EF-44A release agent, whereby the halogen-free composition is calendered and irradiated pursuant to the procedures disclosed herein. In addition, various embodiments of the electrical tape of the present invention, including halogen-free electrical tapes of the present invention, meet at least one of the UL 510 requirements. Furthermore, various embodiments of the electrical tape of the present invention, including halogen-free electrical tapes of the present invention, meet a plurality of the UL 510 requirements.

### Test Methods

Various analytical techniques can be used to characterize the properties of the composition of the present invention. A brief explanation of these analytical techniques follows.

Flame Retardance

The flame retardance of tapes produced in accordance with the present invention that include backing and a layer of acrylic adhesive may be tested according to the procedures of UL 510. The test involves wrapping three tape strips around a steel rod so that six thicknesses of tape result at each point along the wrapped rod. The wrapped rod is exposed to a test flame and the burn time for the tape is measured. This process is repeated for a total of five flame applications and the results are analyzed according to the criteria set forth in UL 510 to determine whether the tape qualifies as “flame retardant.”

Physical Property Tests

Tensile strength and elongation of film and electrical insulating tapes produced in accordance with the present invention may be determined using the procedures of UL 510 for PE thermoplastic tape. The standard requires a minimum ultimate elongation of 60% and a minimum tensile strength of 1500 psi. The presence or absence of adhesive on the film does not appreciably alter the tensile strength and/or elongation of the film. As such, some of the tensile strength and elongation tests were conducted on samples produced in the Examples below using film free of adhesive.

Dielectric Breakdown Test

Dielectric strength of electrical insulating tapes produced in accordance with the present invention may be determined using the procedures of UL 510 for PE thermoplastic tape. The standard requires an average dielectric strength of at least 1,000 volts per mil (39.37 kilovolts per millimeter) of tape thickness.

Moisture Absorption Test

The ability of electrical insulating tapes produced in accordance with the present invention to retain at least 90% of the original average dielectric strength of the tape after prolonged conditioning of the tape in humid conditions may be determined using the procedures of UL 510.

### EXAMPLES

The present invention is more particularly described in the following examples that are intended as illustrations only, because numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

The following is a brief overview of the various examples. Examples 1-5 illustrate the effects that different concentrations of flame retardant in halogen-free compositions of the present invention have on the flame retardancy, the tensile strength, and the elongation of halogen-free film and/or halogen free tape manufactured from the halogen free composition. Examples 6-20 illustrate the effects that different concentrations of processing additives in halogen-free composition of the present invention have on the various physical properties of halogen-free film and/or halogen-free tape manufactured from the halogen-free composition.

The following compositional abbreviations are used in the Examples:
ATH: Silated alumina trihydrate flame retardant, commercially available from J.M. Huber Corporation of Edison, N.J. under the trade designation “DP-6033.”
CAPS: A neoalkoxy-titanate coupling agent, commercially available from Kenrich Petrochemicals, Inc. of Bayonne, N.J.
D-148 Dry Lubricant: A processing aid commercially available from C.P. Hall Company of Chicago, Ill.
ELVAX 470: An ethylene vinyl acetate polymer commercially available from DuPont of Wilmington, Del.
EPOLENE C16: A maleated polyethylene commercially available from Eastman Chemical Company of Kingsport, Tenn.
EPOLENE G3003: A maleated polypropylene commercially available from Eastman Chemical Company of Kingsport, Tenn.
EXACT 4056: An ethylene-based hexene plastomer commercially available from Exxon Mobil of Irving, Tex.
IRGANOX 1010: A surfactant commercially available from Showa Denko K.K. of Tokyo, Japan.
KELTAN 7506: A terpolymer of an ethylene-propylene-diene monomer commercially available from DSM Elastomers Americas of Baton Rouge, La.
LD 140: A low density-polyethylene commercially available from Exxon Mobil of Irving, Tex.
MB950: Carbon black dispersed in EVA, commercially available from Modern Dispersion, Inc.
MONDUR MR: An isocyanate polyurethane pre-polymer commercially available from Bayer Corp., of Leverkusen, Germany.
RX-13824: A plasticizer commercially available from C.P. Hall Company of Chicago, Ill.
SCOTCHCAST2130 part A: A polyurethane pre-polymer resin commercially available from 3M Company of St. Paul, Minn.
SILQUEST A189: A silane-based coupling agent commercially available from OSI Specialties Division of Witco Corporation of Danbury, Conn.
STRUKTOL EF-44 A: A processing aid mixture of a fatty acid metal soap and an amide, commercially available from Struktol Company of America of Stow, Ohio.
   Precursor

A precursor was prepared by combining the components listed in Table 1 at the indicated concentrations in a Banbury mixer running at 45 rpm for 5 minutes at a component temperature (in the mixer) of 140° C. The composition was further mixed in a two-roll mill, and strips with a cross-section of 3.0 inches by 0.5 inches were cut, fed into an extruder and, screened and pelletized. The temperatures within the extruder did not exceeded 150° C.

TABLE 1
Precursor Formulation

| Components | Concentration (weight %) |
|---|---|
| ELVAX 470 EVA | 25.0 |
| KELTAN 7506 EPDM | 6.0 |
| ATH flame retardant | 60.0 |
| MB950 Carbon Black | 7.0 |
| D-148 Dry Lubricant | 1.5 |
| IRGANOX 1010 Anti-Oxidant | 0.5 |
| Total | 100.0 |

### Examples 1-5

Example 1 was prepared using a Banbury mixer and a two-roll mill. Precursor pellets were placed in the Banbury mixer and preheated to 180° F. and operated at 65 rpm. The pellets were mixed and melted for two minutes until the composition was in the range of 240 to 250° F. The STRUKTOL EF-44A release agent was blended with the precursor in the mixer to form the composition of Example 1. This composition of Example 1 was mixed at 45 rpm in the Banbury mixer for 3 minutes, while keeping the composition between 240 and 260° F. The mixing speed of the Banbury mixer was then increased to 65 rpm and the composition was allowed to reach 290° F. The composition of Example 1 was then transferred to a 2-roll mill, milled and banded for 5 minutes. The resulting composition of Example 1 was then fed into a four-roll calender machine to form a film. The first three calender rolls contact the composition (i.e., the upper two calender rolls and the middle calender roll) exerted pressure on the film, while the fourth roll (i.e., the lower roll) did not. The roll temperatures were set at 210° F. for the upper two rolls and at 205° F. for the middle roll.

Examples 2-5 were based on the precursor and included increasing amounts of the STRUKTOL EF-44A release agent and increasing amounts of the ATH flame retardant, beyond what is used in the precursor, as listed in Table 2. The compositions of Examples 2-5 were each mixed and sheeted into films using the procedure of Example 1. The STRUKTOL EF-44A release agent and the additional ATH flame retardant for the compositions of Examples 2-5 were added at the same time the STRUKTOL EF-44A release agent was added during preparation of the composition of Example 1.

TABLE 2

| | | | STRUKTOL | ATH flame |
|---|---|---|---|---|
| | ATH | Precursor | EF-44A | retardant |
| Composition | (g) | (g) | Release Agent (g) | (measured wt %)* |
| Example 1 | 0.00 | 1900.00 | 27 | 59 |
| Example 2 | 118.75 | 1781.25 | 27 | 62 |
| Example 3 | 237.50 | 1662.50 | 32 | 64 |
| Example 4 | 356.25 | 1543.75 | 33 | 66 |
| Example 5 | 475.00 | 1425.00 | 34 | 69 |

*based on the total weight of the composition of the particular example and measured by thermo-gravenmetric analysis

The films produced in Examples 1-5 were irradiated with an electron-beam to determine any effects of electron-beam irradiation on the tensile strength and elongation of the films. Both irradiated and non-irradiated films of Examples 1-5 were tested for tensile strength and elongation according to the procedures of UL 510. The results of these tests are shown in Table 3. The irradiated films were subjected to a total irradiation dosage of 35 Mrad. The irradiation dosages were applied using an electron-beam generator with the following beam parameters: a voltage setting of 175 keV, a line speed of 20 feet per minute, a current of 7 mA, and a K machine constant of 80.

As shown in Table 3, the tensile strength and elongation for both the irradiated and non-irradiated films of Examples 1-5 decreased as the weight percent concentration of ATH flame retardant increased. For the composition of Examples 1-5, the irradiated film exhibits a higher tensile strength and elongation than the non-irradiated film version of the same composition. Increased cross-linking of the polymeric material included in the films of Examples 1-5, attributable to the electron-beam irradiation, is believed responsible for these tensile strength and elongation increases.

TABLE 3
Effect of e-beam Irradiation

| | | Tensile Strength | Elongation |
|---|---|---|---|
| Composition | Irradiated | (psi) | (%) |
| Example 1 | Yes | 1345 | 205 |
| Example 2 | Yes | 1234 | 145 |
| Example 3 | Yes | 1084 | 134 |
| Example 4 | Yes | 1060 | 118 |
| Example 5 | Yes | 940 | 75 |
| Example 1 | No | 1121 | 177 |
| Example 2 | No | 1035 | 120 |
| Example 3 | No | 939 | 115 |
| Example 4 | No | 876 | 106 |
| Example 5 | No | 881 | 65 |

One major surface of each irradiated film produced in Examples 1-5 was coated with acrylic adhesive to form halogen-free electrical insulating tapes that were tested for flame retardancy according to Section 4 of UL 510. Ten different specimens were tested for each example. The flame retardancy test results for the electrical insulating tapes of Examples 1-5 are presented in Table 4, which reports the total numbers of samples that passed the test of the ten total samples.

TABLE 4

| Composition | Film Thickness (mil) | Pass Specimens |
|---|---|---|
| Example 1 | 8.0 | 6 |
| Example 2 | 6.0 | 9 |
| Example 3 | 7.0 | 10 |
| Example 4 | 7.5 | 10 |
| Example 5 | 7.0 | 10 |

### Examples 6-8

Examples 6-8 were based on composition of Example 3, and additionally include increasing amounts of the EPOLENE G3003 maleated polyolefin coupling agent. The component balance of the compositions of Examples 6-8 consisted of the composition of Example 3. The compositions of Examples 6-8 were mixed in a Banbury similar to that of Examples 1-5 and extruded into films on a laboratory extruder using procedures known in the art. The composition of Example 3 was hot pressed between heated platens to form films having a thickness between 25 to 35 mil.

Film samples of Examples 3 and 6-8 were tested for tensile strength and elongation according to UL 510 for PE thermoplastic tape and the results are provided in Table 5. The film of Example 3 served as a control.

TABLE 5

| | EPOLENE G3003 coupling | Tensile Strength | Elongation |
|---|---|---|---|
| Components | agent (wt. %)* | (psi) | (%) |
| Example 3 | 0.0% | 1300 | 340 |
| Example 6 | 2.5% | 1500 | 260 |
| Example 7 | 5.0% | 1700 | 160 |
| Example 8 | 10.0% | 2200 | 70 |

*based on the total weight of the composition of each particular each example

### Examples 9-12

Examples 9-12 were based on Example 1 and included increasing amounts of the SCOTCHCAST 2130 Part A polyurethane pre-polymer coupling agent, as indicated in Table 6. The component balances for the compositions of Examples 9-12 consisted of the composition of Example 1. The compositions of Examples 9-12 were mixed and pressed into film using the methods previously described.

Film samples of Examples 9-12 were tested for tensile strength and elongation according to the UL 510. The results of these tests are shown in Table 6. The SCOTCHCAST 2130 Part A coupling agent improved the tensile strength of all the films of Examples 9-12, as compared to the tensile strength of the film prepared from the Example 1.

TABLE 6

| | SCOTCHCAST 2130 Part | Tensile Strength | Elongation |
|---|---|---|---|
| Composition | A Coupling Agent (wt. %)* | (psi) | (%) |
| Example 1 | 0 | 1091 | 44 |
| Example 9 | 2.5% | 1223 | 43 |
| Example 10 | 5.0% | 1325 | 40 |
| Example 11 | 7.5% | 1532 | 52 |
| Example 12 | 10% | 1522 | 53 |

*based on the total weight of the composition of each particular each example

### Examples 13-20

Examples 13-20 contained the precursor and additionally include STRUKTOL EF-44A release agent, CAPS coupling agent, EXACT 4056 ethylene-based hexene plastomer, ELVAX 470 EVA, KELTAN 7506 EPDM, RX-13824 plasticizer, MONDUR MR coupling agent, and/or SILQUEST A189 coupling agent. Table 7 indicates the amount of each component (in grams) added to the pre-mixed composition of Comparative Example A to form the compositions of Examples 13-20. The compositions of Examples 13-20 were mixed, extruded into film, and calendered according to the procedures previously described for production of the films of Examples 1-5. The samples of Examples 13-20 were also tested according to UL 510 for PE thermoplastic tape, and the results are included in Table 7.

TABLE 7

| Components (g) | Ex. 13 | Ex. 14 | Ex. 15 | Ex. 16 | Ex. 17 | Ex. 18 | Ex. 19 | Ex. 20 |
|---|---|---|---|---|---|---|---|---|
| Precursor | 1900 | 1881 | 1786 | 1786 | 1831 | 1850 | 1848 | 65 |
| STRUKTOL EF-44A Release Agent | 17 | 17 | 17 | 17 | 17 | 20 | 0 | 0 |
| CAPS Coupling Agent | 0 | 19 | 19 | 19 | 19 | 19 | 0 | 0 |
| EXACT 4056 Plastomer | 0 | 0 | 95 | 0 | 0 | 0 | 0 | 0 |
| ELVAX 470 EVA | 0 | 0 | 0 | 95 | 0 | 0 | 0 | 0 |
| KELTAN 7506 EPDM | 0 | 0 | 0 | 0 | 95 | 0 | 0 | 0 |
| RX-13824 Plasticizer | 0 | 0 | 0 | 0 | 0 | 31 | 0 | 0 |
| MONDUR MR Coupling Agent | 0 | 0 | 0 | 0 | 0 | 0 | 52 | 0 |
| SILQUESTA 189 Coupling Agent | 0 | 0 | 0 | 0 | 0 | 0 | 0 | 2.15 |
| Tensile Strength (psi) | 1480 | 1800 | 2010 | 1917 | 1418 | 1890 | 1980 | 1042 |
| Elongation (%) | 37 | 61 | 50 | 40 | 76 | 49 | 39 | 55 |

The films of Examples 14, 15, 16, 18, and 19 exhibited tensile strengths in excess of the 1500 psi minimum requirement of UL 510. The films of Examples 14 and 17 had elongations in excess of the 60% minimum requirement of UL 510. Thus, the film of Example 14 exhibited both a tensile strength and an elongation in compliance with UL 510, for PE thermoplastic tape. The composition of Example 14 containing the CAPS coupling agent was calendered to form a film. The calender machine had two upper rolls, a middle roll, and a lower roll. The lower roll exerted no pressure on the film. The two upper rolls had hot liquid circulating through them; the liquid temperature of 200° F. The middle roll had temperature set point of 190° F. Acrylic adhesive was applied to one major surface of the calendered film using the method described for Examples 1-5. The tape was then tested for flame retardancy using the procedures of UL 510. Three samples of tape were exposed five successive times to the test flame. All the samples passed the flame test.

Dielectric Strength Test for Example 14

The tape based on the composition of Example 14 was tested for dielectric strength and moisture absorption (i.e., retention of dielectric strength after moisture challenge) using the procedures of UL 510 (§§ 8 & 10) for PE thermoplastic tape. Twelve different samples of the tape based on the composition of Example 14 were tested; the results of this testing are shown in Table 8. The column in Table 8 labeled “Dielectric Strength” indicates the UL 510 dielectric breakdown test results. The column labeled “Retention of Dielectric Strength” indicates the percent retention, for each sample, of the original dielectric strength of the particular sample after conditioning of the sample for 96 hours in air at 23.0±1.0° C. and a relative humidity of 96%+2%, when tested pursuant to the procedures of UL 510 for PE thermoplastic tape.

UL 510 specifies the average dielectric strength of five specimens of finished tape should not be less than 1,000 volts per mil (V/mil) of tape thickness. All 12 tape samples depicted in Table 8 had a dielectric strength greater than 1,000 volts per mil (V/mil) of tape thickness. Therefore, the tape based on the composition of Example 14 meets the UL 510 dielectric strength requirement for PE thermoplastic tape.

Ten of the 12 tape samples included in Table 8 retained at least 90% of the original average dielectric strength. The average percent retention of dielectric strength was 98.7%, which exceeds the UL 510 minimum retention of 90.0% for PE thermoplastic tape. Therefore, the tape of Example 14 meets the UL 510 moisture absorption requirement for PE thermoplastic tape.

TABLE 8
Dielectric Strength Test based on Composition of Example 14

| | | Retention of Dielectric Strength |
|---|---|---|
| Sample | Dielectric Strength (V/mil) | (%) |
| 1 | 1553 | 82.1 |
| 2 | 1506 | 93.4 |
| 3 | 1532 | 98.4 |
| 4 | 1561 | 87.4 |
| 5 | 1488 | 104.8 |
| 6 | 1475 | 104.5 |
| 7 | 1463 | 103.4 |
| 8 | 1415 | 105.1 |
| 9 | 1487 | 103.8 |
| 10 | 1469 | 108.0 |
| 11 | 1500 | 99.1 |
| 12 | 1526 | 92.9 |
| Average | 1498 | 98.7 |

Although the present invention has been described with reference to preferred embodiments, workers skilled in the art will recognize that changes may be made in form and detail without departing from the spirit and scope of the invention.

1. A composition comprising:
a halogen-free polymeric material;
a halogen-free flame retardant; and
a coupling agent.

2. The composition of claim 1, wherein the composition comprises at least about 40 weight percent of the halogen-free flame retardant, based on the total weight of the composition.

3. The composition of claim 1, wherein the coupling agent comprises a non-silane coupling agent.

4. The composition of claim 1, further comprising a release agent.

5. The composition of claim 1, wherein the halogen-free polymeric material comprises a terpolymer of an ethylene-propylene-diene monomer.

6. The composition of claim 1, wherein the halogen-free polymeric material comprises an ethylene vinyl acetate polymer.

7. The composition of claim 6, wherein the halogen-free polymeric material further comprises a terpolymer of an ethylene-propylene-diene monomer.

8. The composition of claim 4, wherein the release agent comprises a fatty acid metal soap.

9. A tape comprising:
a backing formed from the composition of claim 1; and
an adhesive located on a surface of the backing, the tape, when tested in accordance with the procedures of Underwriters Laboratories UL 510, Seventh Edition, exhibits at least one of the physical properties selected from the group consisting of:
an elongation at break of at least about 60%;
a tensile strength at break of at least about 1500 psi;
a dielectric strength of at least about 1,000 V per mil of tape thickness;
an average adhesion strength of at least about 0.175 N/mm; and
a retention of at least 90 percent of an original average dielectric strength after the tape is conditioned for 96 hours in air with a temperature of about 23.0° C. and a relative humidity of about 96%.

10. A method of making a composition, the method comprising blending together a halogen-free polymeric material, a halogen-free flame retardant, and a coupling agent.

11. The method of claim 10, wherein the halogen-free polymeric material comprises a terpolymer of an ethylene-propylene-diene monomer.

12. The method of claim 10, wherein the halogen-free polymeric material comprises an ethylene vinyl acetate polymer.

13. The method of claim 10, wherein the halogen-free polymeric material further comprises a terpolymer of an ethylene-propylene-diene monomer.

14. The method of claim 10 further comprising a release agent.

15. The method of claim 14, wherein the release agent comprises a fatty acid metal soap.

16. The method of claim 10, wherein the coupling agent comprises a non-silane coupling agent.

17. A method of making tape, the method comprising:
forming the composition of claim 1 into a backing; and
applying an adhesive to a surface of the backing to form the tape, wherein the tape, when tested in accordance with the procedures set forth in Underwriters Laboratories UL 510, Seventh Edition exhibits at least one of the physical properties selected from the group consisting of:
an elongation at break of at least about 60%;
a tensile strength at break of at least about 1500 psi;
a dielectric strength of at least about 1,000 V per mil of tape thickness;
an average adhesion strength of at least about 0.175 N/mm; and
a retention of at least 90% of an original average dielectric strength after the tape is conditioned for 96 hours in air with a temperature of about 23.0° C. and a relative humidity of about 96%.

18. The method of claim 17, wherein said forming step comprises calendering.

19. The method of claim 17 further comprising the step of irradiating the backing or the tape with electron beam.
